(19) United States
(12) Patent Application Publication
(10) Pub. No.: US 2013/0168214 A1
(43) Pub. Date: Jul. 4, 2013

(54) THIN PROFILE KEYBOARD

(71) Applicants: KE-JIAN LIOU, Taichung City (TW); Shuo-Hung Chang, Taichung City (TW)

(72) Inventors: KE-JIAN LIOU, Taichung City (TW); Shuo-Hung Chang, Taichung City (TW)

(73) Assignee: Sunrex Technology Corp., Taichung City (TW)

(21) Appl. No.: 13/340,421

(22) Filed: Dec. 29, 2011

(51) Int. Cl. H01H 13/76

(52) U.S. Cl. 200/5 A

(57) ABSTRACT

A thin profile keyboard is provided with a monoblock having a plurality of rectangular openings arranged in rows, and a plurality of bottom grooves; a plurality of keys each including a rectangular frame movably disposed in the opening of the monoblock, and two lever arms extending from both ends of a forward edge of frame, each lever arm filled in the bottom groove; a printed circuit board (PCB) disposed below the keys and the monoblock; and a base disposed below the PCB. The base, the monoblock, and the PCB are assembled.

### BACKGROUND OF THE INVENTION

1. Field of the Invention

The invention relates to computer keyboards, and more particularly to a thin profile keyboard for laptop.

2. Description of Related Art

Laptops are widely used throughout the world. Laptops are advantageous for being lightweight, portable, low profile, and having features very dose to that of desk top computers.

Typically, a laptop is equipped with a scissor-switch keyboard. In detail, a plurality of scissor switches each are mounted between a key and a base plate. Scissor-switch keyboards are advantageous for being lightweight and easy operation. However, its assembly is a time consuming and tedious job due to its layered structure. This inevitably decreases production and greatly increases the manufacturing cost. Further, the layered structure may compromise the goal of rendering a low profile keyboard. Thus, improvements for scissor-switch keyboards still exist.

There is a typical type of computer keyboard comprising a base, a monoblock, and a plurality of keys each including a keycap and two extensions (e.g., two arms) projecting out of the keycap, the extensions being retained between the base and the monoblock and pivotably secured to the base. A pressing of the key may pivot the keycap about the base.

However, force exerted on one extension may be not equal to that exerted on the other extension due to different pressing positions of the fingers on the keys. As a result, a character being keyed in may not appear on the screen as a computer user thinks. Thus, the need for improvement of computer keyboards still exists.

### SUMMARY OF THE INVENTION

It is therefore one object of the invention to provide a keyboard comprising a monoblock comprising a plurality of rectangular openings arranged in rows, and a plurality of bottom grooves; a plurality of keys each comprising a rectangular frame movably disposed in the opening of the monoblock, and two lever arms extending from both ends of a forward edge of frame, each lever arm fitted in the bottom groove; a printed circuit board (PCB) disposed below the keys and the monoblock; and a base disposed below the PCB, wherein the base, the monoblock, and the PCB are assembled.

The above and other objects, features and advantages of the invention will become apparent from the following detailed description taken with the accompanying drawings.

### BRIEF DESCRIPTION OF THE DRAWINGS

FIG. 1 is an exploded view of a thin profile keyboard according to the invention;

FIG. 2 is an enlarged view of an upper portion of FIG. 1 with the monoblock being turned upward to be assembled the key;

FIG. 3 is a perspective view of the assembled keyboard;

FIG. 4 is a longitudinal sectional view of FIG. 3;

FIG. 5 is a view similar to FIG. 4 where the key is depressed; and

FIG. 6 is a view similar to FIG. 4 showing an additional liquid crystal displaying board being mounted below the base.

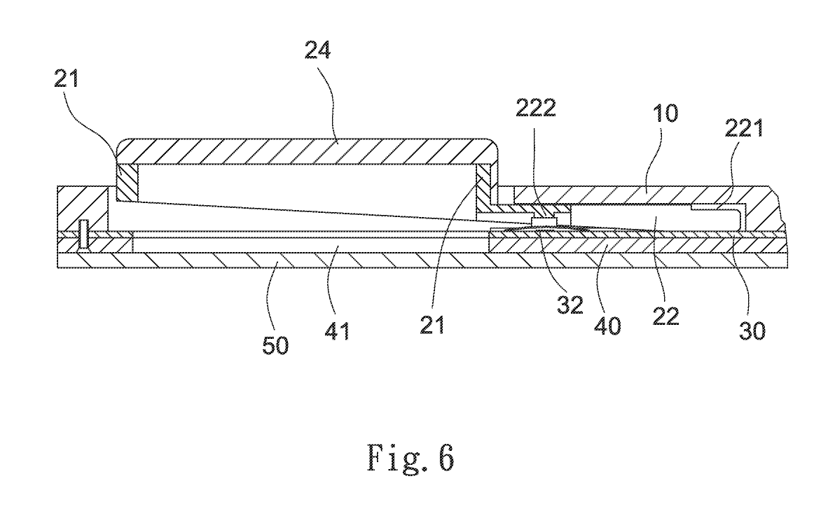

### DETAILED DESCRIPTION OF THE INVENTION

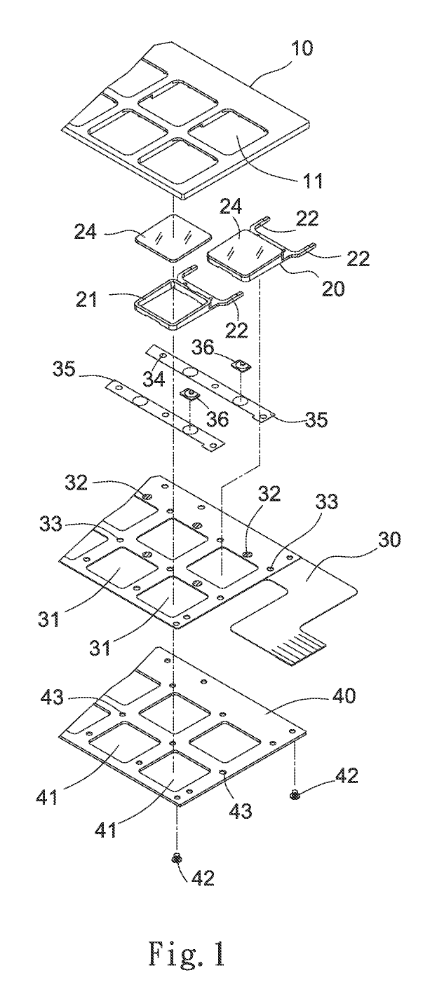

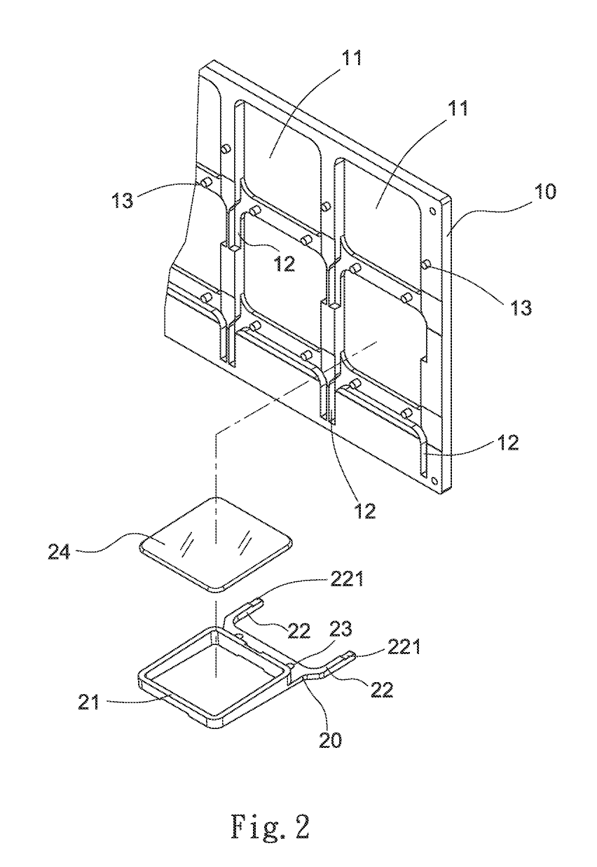

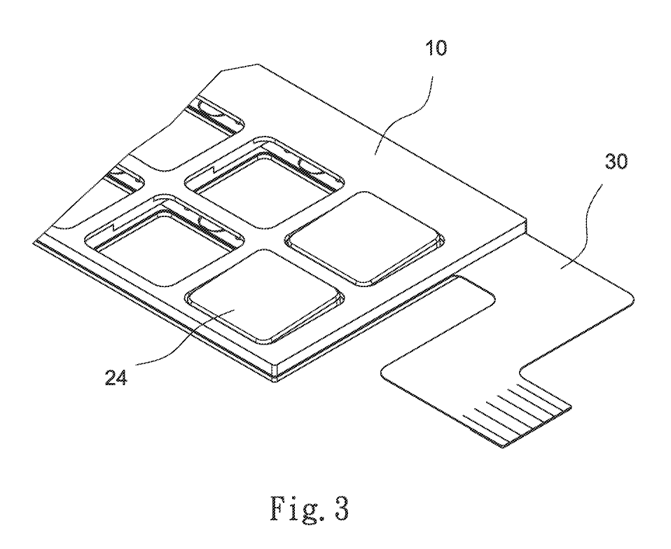

Referring to FIGS. 1 to 5, a thin profile keyboard in accordance with the invention comprises from top to bottom the following components as discussed in detail below.

A monoblock 10 is rectangular and comprises a plurality of rectangular openings 11 arranged in rows, a plurality of equally spaced grooves 12 on a front end of the bottom, and a plurality of bottom pegs 13 adjacent the edges of the openings 11.

A plurality of keys 20 are formed of rigid material. Each key 20 is correspondingly disposed in the opening 11. The key 20 comprises a rectangular frame 21; two lever arms 22 extending from both ends of a forward extending edge of frame 21, each lever arm 22 including a recess 221 at an open end, two spaced holes 23 on the forward extending edge of the frame 21 between the lever arms 22; a stern 222 extending downward from the forward extending edge of the frame 21; and a rectangular keycap 24 secured onto the frame 21. A character or a function symbol is printed on the keycap 24. That is, a keyboard layout is formed on the keycaps 24. Alternatively the keycap 24 is transparent and without any characters printed thereon.

A thin printed circuit board (PCB) 30 comprises a plurality of rectangular openings 31, a plurality of conductive contacts 32 on a top surface, a plurality of first through holes 33 on the top surface, a plurality of adhesive strips 35 each with a second through hole 34 formed therethrough, and a plurality of resilient members 36 formed of metal, each resilient member 36 being secured to the adhesive strip 35, aligned with the contact 32 therebelow, and spaced from the contact 32 by a small distance. A base 40 comprises a plurality of rectangular openings 41, a plurality of fasteners (e.g., screws) 42, and a plurality of positioning holes 43.

An assembly of the invention will be described in detailed below. The lever arms 22 are fitted in the grooves 12 with both the frame 21 and the keycap 24 slightly projecting out of the opening 11. Align the resilient member 36 with the stem 222 and engage the resilient member 36 with the stem 222. Thus, the keycaps 24 and the openings 31 are aligned. Further, align the openings 31 with the openings 41. The pegs 13 are inserted through the holes 23, the second through holes 34, and the first through holes 33 into the positioning holes 43 to position the monoblock 10 the keys 20, the adhesive strips 35, the PCB 30, and the base 40. Finally, the screws 42 are driven through the base 40 and the PCB 30 into the monoblock 10 to fasten the base 40, the PCB 30, and the monoblock 10 together with the keys 20 being anchored in place.

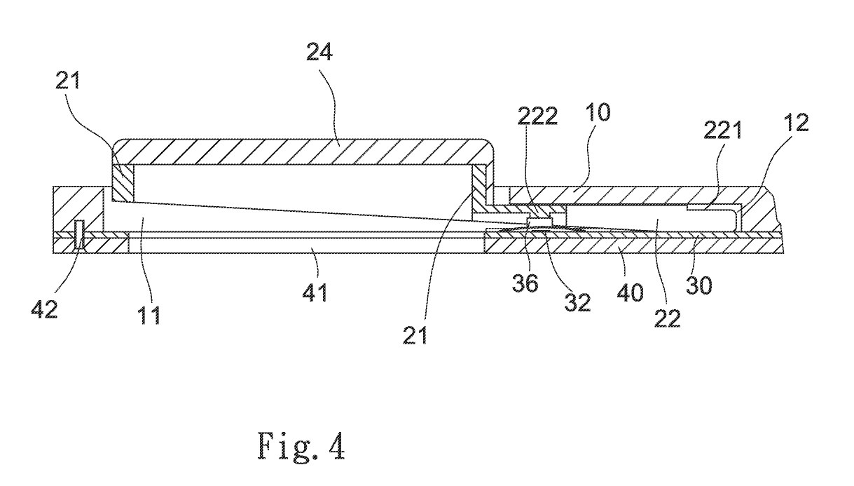

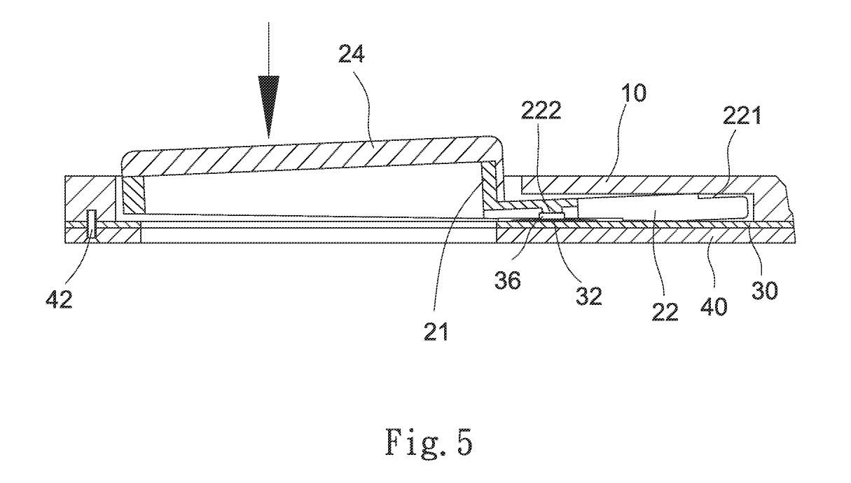

In use (see FIGS. 4 and 5), a computer user may press the keycap 24 to cause the lever arms 22 to turn about its middle portions. Further, the stem 222 is lowered to press the resilient member 36. And in turn, the contact 32 is electrically connected to the PCB 30 to send scan codes to the operating system of a computer (e.g., laptop computer) for processing. This finishes a key press. Note that the provision of the resilient member 36 provides an audible alert (e.g., click) to the user when pressing the keycap 24.

Referring to FIG, 6 in conjunction with FIGS. 1 to 5, a liquid crystal displaying board 50 is additionally mounted on the bottom of the base 40. The provision of the liquid crystal displaying board 50 is only necessary when the keycaps 24 are transparent and without characters printed thereon so that the characters on the liquid crystal displaying board 50 can be seen through the keycaps 24, the openings 11, the openings 31, and the openings 41 from above.

It is noted that characters shown on the liquid crystal displaying board 50 can be controlled by computer software. That is, the liquid crystal displaying board 50 is an intelligent liquid crystal displaying board. Thus, different keyboard layouts can be carried out by the liquid crystal displaying board 50.

While the invention has been described in terms of preferred embodiments, those skilled in the art will recognize that the invention can be practiced with modifications within the spirit and scope of the appended claims.

What is claimed is:

1. A keyboard comprising:
a monoblock comprising a plurality of rectangular openings arranged in rows, and a plurality of bottom grooves;
a plurality of keys each comprising a rectangular frame movably disposed in the opening of the monoblock, and two lever arms extending from both ends of a forward edge of frame, each lever arm fitted in the bottom groove;
a printed circuit board (PCB) disposed below the keys and the monoblock; and
a base disposed below the PCB.
wherein the base, the monoblock, and the PCB are assembled.

2. The keyboard of dam 1, wherein the monoblock further comprises a plurality of bottom pegs adjacent the openings thereof, the bottom pegs being inserted through the PCB into the base for positioning.

3. The keyboard of claim 2, wherein the keys are formed of rigid material, each lever arm includes a recess at one end, and each key further includes two spaced holes on the forward edge of the frame between the lever arms so that each bottom peg inserts through the hole for positioning.

4. The keyboard of claim 1, wherein each key further comprises a stem extending downward from the forward edge of the frame, and the PCB comprises a plurality of conductive top contacts so that a movement of the stem contacting the conductive top contact causes the PCB to perform a key press operation.

5. The keyboard of claim 4, wherein the PCB further comprises a plurality of adhesive strips secured thereon, and a plurality of resilient members formed of metal, each resilient member being secured to the adhesive strip, aligned with the stem thereabove, and aligned with the conductive top contact therebelow.

6. The keyboard of claim 1, wherein each key further comprises a keycap having a character or a function symbol printed thereon.

7. The keyboard of claim 1, wherein the PCB comprises a plurality of rectangular openings, the base comprises a plurality of rectangular openings, and the opening of both the PCB and the base are aligned with the openings of the monoblock, the keyboard further comprising a liquid crystal displaying board mounted under the base, the liquid crystal displaying board having one of a plurality of different keyboard layouts shown thereon by executing software.

8. The keyboard of claim 7, wherein each key further comprises a transparent keycap so as to view the keyboard layout of the liquid crystal displaying board through the keycaps, the openings of the monoblock, the openings of the PCB, and the openings of the base.
